(19) United States
(12) Patent Application Publication
(10) Pub. No.: US 2021/0027178 A1
(43) Pub. Date: Jan. 28, 2021

(54) RECOMMENDATION METHOD AND RECOMMENDATION APPARATUS BASED ON DEEP REINFORCEMENT LEARNING, AND NON-TRANSITORY COMPUTER-READABLE RECORDING MEDIUM

(71) Applicants: Lei DING, Beijing (CN); Yixuan TONG, Beijing (CN); Bin DONG, Beijing (CN); Shanshan JIANG, Beijing (CN); Yongwei ZHANG, Beijing (CN)

(72) Inventors: Lei DING, Beijing (CN); Yixuan TONG, Beijing (CN); Bin DONG, Beijing (CN); Shanshan JIANG, Beijing (CN); Yongwei ZHANG, Beijing (CN)

(73) Assignee: Ricoh Company, Ltd., Tokyo (JP)

(21) Appl. No.: 16/934,112

(22) Filed: Jul. 21, 2020

(30) Foreign Application Priority Data
Jul. 26, 2019 (CN) 201910683178.3

(51) Int. Cl. G06N 5/04; G06F 16/9535; G06K 9/62; G06N 3/04; G06F 40/289

(52) U.S. Cl. CPC G06N 5/04; G06F 16/9535; G06F 40/289; G06K 9/6215; G06N 3/0445; G06K 9/6262

(57) ABSTRACT

A recommendation method and a recommendation apparatus based on deep reinforcement learning, and a non-transitory computer-readable recording medium are provided. In the method, entity semantic information representation vectors of products are generated based on a product knowledge graph; browsing context information representation vectors of the products are generated based on historical browsing behavior of a user with respect to products; the entity semantic information representation vectors and the browsing context information representation vectors of the respective products are merged to obtain vectors of the products; a recommendation model based on deep reinforcement learning is constructed, and the recommendation model based on the deep reinforcement learning is offline-trained using historical behavior data of the user to obtain the offline-trained recommendation model, the products in the historical behavior data of the user are represented by the vectors of the products; and products are online-recommended using the offline-trained recommendation model.

### CROSS-REFERENCE TO RELATED APPLICATIONS

The present application claims priority under 35 U.S.C. § 119 to Chinese Application No. 201910683178.3 filed on Jul. 26, 2019, the entire contents of which are incorporated herein by reference.

### BACKGROUND OF THE INVENTION

### 1. Field of the Invention

The present disclosure relates to the field of machine learning, and specifically, a recommendation method and a recommendation apparatus based on deep reinforcement learning, and a non-transitory computer-readable recording medium.

### 2. Description of the Related Art

Recently, with the rapid development of recommendation algorithms, recommendation (recommender) systems have been widely used in various business scenarios. For example, in search engines, recommendation systems provide relevant content based on user input. As another example, in e-commerce websites, recommendation systems recommend a product or the like of interest of a user.

Conventional recommendation algorithms analyze interest of a user based on historical behavior of the user, and then recommend related products. Conventional recommendation algorithms cannot respond to a real-time feedback of a user, meanwhile recommendation algorithms based on deep reinforcement learning overcome the problem. However, recommendation effects of conventional recommendation systems based on deep reinforcement learning at an initial phase of implementing online are usually not good enough to meet the needs of users.

### SUMMARY OF THE INVENTION

According to an aspect of the present disclosure, a recommendation method based on deep reinforcement learning is provided. The method includes generating, based on a product knowledge graph, entity semantic information representation vectors of products; generating, based on historical browsing behavior of a user with respect to products, browsing context information representation vectors of the products; merging the entity semantic information representation vectors and the browsing context information representation vectors of the respective products to obtain vectors of the products; constructing a recommendation model based on deep reinforcement learning, and offline-training, using historical behavior data of the user, the recommendation model based on the deep reinforcement learning, to obtain the offline-trained recommendation model, the products in the historical behavior data of the user being represented by the vectors of the products; and online-recommending one or more products using the offline-trained recommendation model.

According to another aspect of the present disclosure, a recommendation apparatus based on deep reinforcement learning is provided. The apparatus includes a memory storing computer-executable instructions; and one or more processors. The one or more processors are configured to execute the computer-executable instructions such that the one or more processors are configured to generate, based on a product knowledge graph, entity semantic information representation vectors of products; generate, based on historical browsing behavior of a user with respect to products, browsing context information representation vectors of the products; merge the entity semantic information representation vectors and the browsing context information representation vectors of the respective products to obtain vectors of the products; construct a recommendation model based on deep reinforcement learning, and offline-train, using historical behavior data of the user, the recommendation model based on the deep reinforcement learning, to obtain the offline-trained recommendation model, the products in the historical behavior data of the user being represented by the vectors of the products; and online-recommend one or more products using the offline-trained recommendation model.

According to another aspect of the present disclosure, a non-transitory computer-readable recording medium having computer-executable instructions for execution by one or more processors is provided. The computer-executable instructions, when executed, cause the one or more processors to carry out a recommendation method based on deep reinforcement learning. The method includes generating, based on a product knowledge graph, entity semantic information representation vectors of products; generating, based on historical browsing behavior of a user with respect to products, browsing context information representation vectors of the products; merging the entity semantic information representation vectors and the browsing context information representation vectors of the respective products to obtain vectors of the products; constructing a recommendation model based on deep reinforcement learning, and offline-training, using historical behavior data of the user, the recommendation model based on the deep reinforcement learning, to obtain the offline-trained recommendation model, the products in the historical behavior data of the user being represented by the vectors of the products; and online-recommending one or more products using the offline-trained recommendation model.

### BRIEF DESCRIPTION OF THE DRAWINGS

The above and other objects, features and advantages of the present disclosure will be further clarified by describing, in detail, embodiments of the present disclosure in combination with the drawings.

FIG. 1 is a schematic diagram illustrating a product knowledge graph according to an embodiment of the present disclosure.

FIG. 2 is a flowchart illustrating a recommendation method based on deep reinforcement learning according to an embodiment of the present disclosure.

FIG. 3 is a flowchart illustrating a step of generating entity semantic information representation vectors of products according to the embodiment of the present disclosure.

FIG. 4 is a schematic diagram illustrating offline training of a recommendation model according to the embodiment of the present disclosure.

FIG. 5 is a block diagram illustrating the configuration of a recommendation apparatus based on deep reinforcement learning according to an embodiment of the present disclosure.

FIG. 6 is a block diagram illustrating the configuration of a recommendation apparatus based on deep reinforcement learning according to another embodiment of the present disclosure.

### DESCRIPTION OF THE EMBODIMENTS

In the following, specific embodiments of the present disclosure will be described in detail with reference to the accompanying drawings, so as to facilitate the understanding of technical problems to be solved by the present disclosure, technical solutions of the present disclosure, and advantages of the present disclosure. The present disclosure is not limited to the specifically described embodiments, and various modifications, combinations and replacements may be made without departing from the scope of the present disclosure. In addition, descriptions of well-known functions and constructions are omitted for clarity and conciseness.

Note that “one embodiment” or “an embodiment” mentioned in the present specification means that specific features, structures or characteristics relating to the embodiment are included in at least one embodiment of the present disclosure. Thus, “one embodiment” or “an embodiment” mentioned in the present specification may not be the same embodiment. Additionally, these specific features, structures or characteristics may be combined in any suitable manner in one or more embodiments.

Note that steps of the methods may be performed in time order, however the performing the described steps may be performed in parallel or independently.

An object of the embodiments of the present disclosure is to provide a recommendation method and a recommendation apparatus based on deep reinforcement learning, and a non-transitory computer-readable recording medium, which pre-train a recommendation model offline using a product knowledge graph and historical browsing behavior of a user, thereby improving the recommendation effect of the recommendation model at an initial phase of implementing online.

A knowledge graph describes relations between different information in a real world by a semantic web. The knowledge graph is mainly expressed and stored by triplets such as <entity, relation, entity>, <entity, attribute, attribute value> and the like, such as <iPhone6, brand, Apple>, <iPhone6, price, 4999 CNY> and the like. The triplet <entity, relation, entity> is an entity topology-relation triplet, the first element and the last element of the triplet are two entities, and the middle element is a relation between the two entities. The triplet <entity, attribute, attribute value> is an entity attribute triplet, and the three elements of the triplet are an entity, an attribute of the entity and a specific attribute value of the attribute, respectively. The knowledge graph is a relational network obtained by connecting different types of information (Heterogeneous Information) together. The knowledge graph provides an ability to analyze problems from a “relationship” perspective. The product knowledge graph in an embodiment of the present disclosure includes triplets of entity topology-relations between one or more product entities to be recommended and related product entities, and also includes triplets of entity attributes of the product entities.

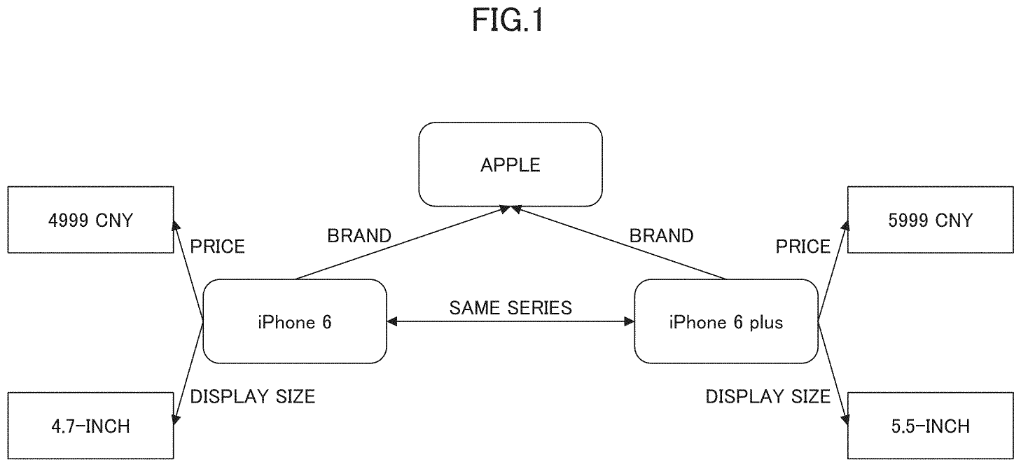

FIG. 1 shows an example of a relation network of a product entity “iPhone 6”. The relation network includes topology relations (such as “same series”, “brand”, and the like) between the product entity and related product entities (such as “iPhone plus”, “Apple”, and the like), and also includes various attributes (such as price, display size, and the like) of the product entity and their attribute values (such as “4999 CNY”, “4.7-inch”, and the like).

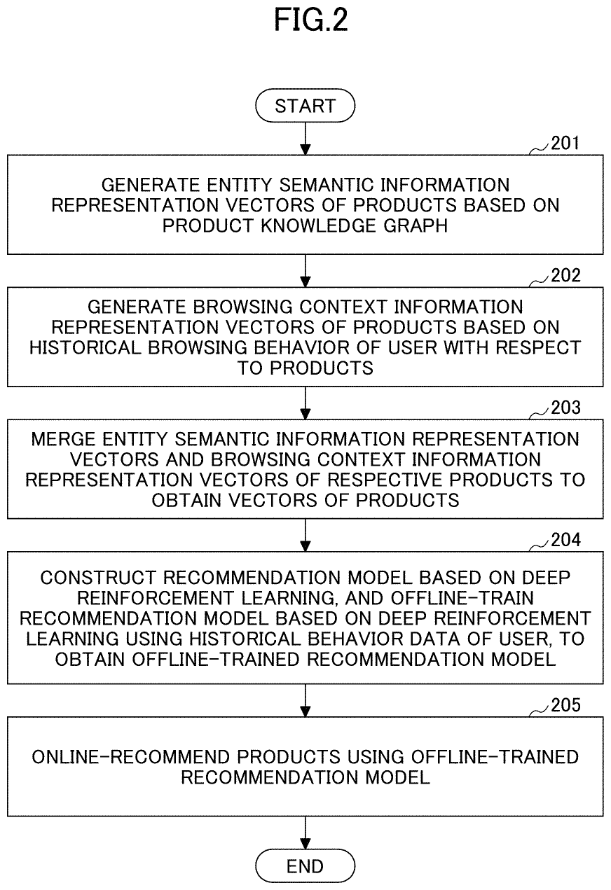

FIG. 2 is a flowchart illustrating a recommendation method based on deep reinforcement learning according to an embodiment of the present disclosure. As shown in FIG. 2, the recommendation method includes the following steps.

In step 201, entity semantic information representation vectors of products are generated based on a product knowledge graph.

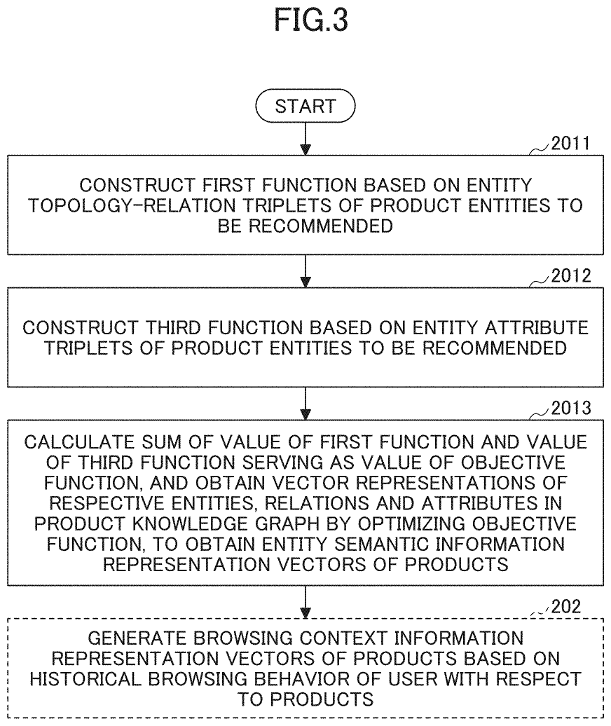

When generating the entity semantic information representation vectors of the products, the recommendation method according to the embodiment of the present disclosure may specifically include the following steps as shown in FIG. 3.

In step 2011, a first function J_{TE} is constructed based on entity topology-relation triplets of product entities to be recommended.

The first function J_{TE} is used to calculate a sum of differences between respective values of a second function based on first triplets and respective values of the second function based on second triplets. The first triplets are the entity topology-relation triplets that exist in the product knowledge graph, and the second triplets are the entity topology-relation triplets that do not exist in the product knowledge graph. Specifically, the second function is a function of a first vector and a second vector, and a value of the second function is positively or negatively related to a distance between the first vector and the second vector. The first vector is a sum of vector representations of the first two elements in the corresponding triplet, and the second vector is a vector representation of the last element in the corresponding triplet.

For example, in the second function based on the first triplet, the first vector is the sum of the vector representations of the first two elements in the first triplet, and the second vector is the vector representation of the last element in the first triplet. Similarly, in the second function based on the second triplet, the first vector is the sum of the vector representations of the first two elements in the second triplet, and the second vector is the vector representation of the last element in the second triplet.

The knowledge graph of the product entities in the embodiment of the present disclosure includes a plurality of the entity topology-relation triplets. In order to construct the first function, second triplets of which the number is approximately the same as the number of the first triplets (for example, at the same order of magnitude as the number the first triplets or an order of magnitude higher than the number of the first triplets) may be constructed based on the entity topology-relation triplets that exist in the product knowledge graph (that is, the first triplets). As a specific construction method, an element in the first triplet may be replaced with another element, to obtain the second triplet that does not exist in the product knowledge graph.

Examples of the above functions are given below. Note that the following examples are only implementation that may be adopted by the embodiment of the present disclosure and the present disclosure is not limited to the examples.

The first function J_{TE} may be calculated based on the following formula.

$${J}_{TE} = {\sum }_{{t}_{r} ∈ {t}_{r}} {\sum }_{{t}_{r}^{′} ∈ {T}_{r}^{′}} [ f ( {t}_{r} ) - f ( {t}_{r}^{′} ) ]$$

The second function f(t) may be calculated based on the following formula.

f(t)=∥h+r−t∥

In the above formulas, tᵣ represents the first triplet, tᵣ′ represents the second triplet, Tᵣ represents the set of the first triplets that exist in the knowledge graph, Tᵣ′ represents the set of the constructed second triplets that do not exist in the knowledge graph, and h, r and t represent the vector representations of the first element, the second element and third element in the triplet t, respectively. The vector representation of each element in the first triplets and the second triplets may be generated by a random initialization algorithm, and a final result of the above vector representation may be obtained by subsequently optimizing an objective function.

In step 2012, a third function J_{AE} is constructed based on entity attribute triplets of the product entities to be recommended.

The third function J_{AE} is used to calculate a sum of differences between respective values of the second function based on third triplets and respective values of the second function based on fourth triplets. The third triplets are the entity attribute triplets that exist in the product knowledge graph, and the fourth triplets are the entity attribute triplets that do not exist in the product knowledge graph.

Similarly, the third function J_{AE} may be calculated based on the following formula.

$${J}_{AE} = {\sum }_{{t}_{a} ∈ {T}_{a}} {\sum }_{{t}_{a}^{′} ∈ {T}_{a}^{′}} [ f ( {t}_{a} ) - f ( {t}_{a}^{′} ) ]$$

In the above formula, tₐ represents the third triplet, tₐ′ represents the fourth triplet, Tₐ represents the set of the third triplets that exist in the knowledge graph, and Tₐ′ represents the set of the constructed fourth triplets that do not exist in the knowledge graph.

The vector representations of the first two elements in the third triplets and the fourth triplets may be generated by a random initialization algorithm, and final results of the above vector representations may be obtained by subsequently optimizing the objective function. For the last elements (that is, attribute values) in the third triplets and the fourth triplets, in order to facilitate calculation, the vector representations of the attribute values may be generated by the following method. The attribute value serving as a character sequence is inputted to a long short-term memory (LSTM) model, the last hidden state of the LSTM model is obtained as an initial value of the vector representation of the attribute value, and the LSTM model is trained by optimizing the objective function described below.

In step 2013, a sum of a value of the first function and a value of the third function is calculated as a value of the objective function, and vector representations of respective entities, relations and attributes in the product knowledge graph are obtained by optimizing the objective function, to obtain the entity semantic information representation vectors of the products.

Specifically, objective function J is calculated based on formula J=J_{TE}+J_{AE}, and vector representations of respective entities, relations and attributes in the product knowledge graph may be obtained by optimizing objective function J. The entities in the knowledge graph include various products to be recommended, accordingly vector representations of respective products (such as iPhone 6), herein referred to as “the entity semantic information representation vectors of the products”, may be obtained.

In step 202, browsing context information representation vectors of the products are generated based on historical browsing behavior of a user with respect to products.

In order to perform offline pre-training, the historical browsing behavior of the user with respect to the products may be obtained. Specifically, a product sequence may be generated in a browsing order from products that are sequentially browsed by the user in the historical browsing behavior, and the product sequence may be inputted to a word-to-vector (Word2vec) model, to obtain vector representations of the respective products, herein referred to as “the browsing context information representation vectors of the products”.

In step 203, the entity semantic information representation vectors and the browsing context information representation vectors of the respective products are merged, to obtain vectors of the products.

For example, the entity semantic information representation vector and the browsing context information representation vector of the product may be spliced in a head-to-tail manner, to obtain a vector with a higher dimension, herein referred to as “the vector of the product”. Specifically, the tail of the entity semantic information representation vector of the product and the head of the browsing context information representation vector of the product may be spliced, or the tail of the browsing context information representation vector of the product and the head of the entity semantic information representation vector of the product may be spliced. The embodiment of the present disclosure is not limited to the above splicing methods.

In step 204, a recommendation model based on deep reinforcement learning is constructed, and the recommendation model based on the deep reinforcement learning is offline-trained using historical behavior data of the user, to obtain the offline-trained recommendation model. The products in the historical behavior data of the user are represented by the vectors of the products.

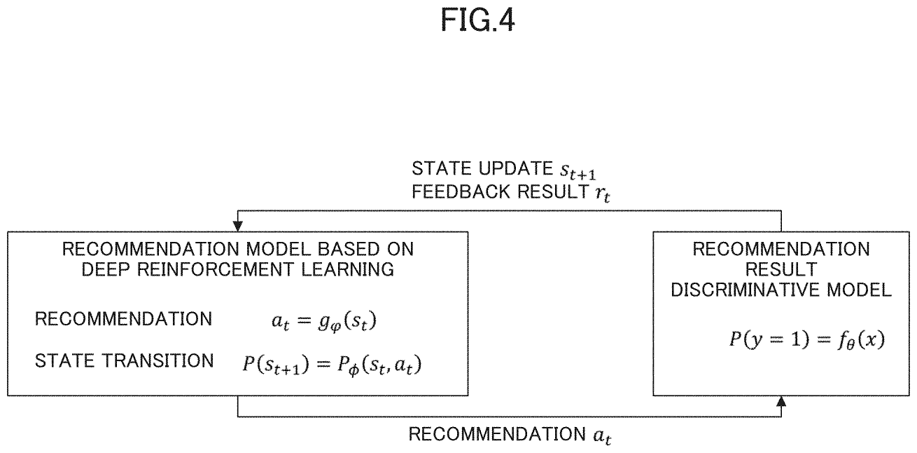

In steps 201 to 203, the vectors of the respective products in the product knowledge map are obtained. Then, the recommendation model based on the deep reinforcement learning and a recommendation result discriminative model shown in FIG. 4 may be constructed and initialized. Then, collaborative training may be performed offline on the recommendation model and the recommendation result discriminative model using the historical behavior data of the user, to iteratively train the above two models alternately. The recommendation result discriminative model evaluates a recommendation result of the recommendation model, and feeds back an evaluation result rₜ to the recommendation model. The recommendation model updates one or more model parameters based on the evaluation result.

Specifically, the recommendation model based on deep reinforcement learning generates a recommendation result based on a current recommendation state, a recommendation strategy and a state transition function, and updates the recommendation state and the recommendation strategy based on feedback of the recommendation result. The recommendation result discriminative model feeds back feedback information indicating whether the recommendation result is good. The recommendation result discriminative model may be any other model independent of the recommendation model based on deep reinforcement learning. The recommendation method according to the embodiment of the present disclosure provides the following two model forms.

(A) Calculation Based on Similarity with Historical Data

The historical behavior data of the user usually includes the following data records.

(sᵢ,aᵢ)→rᵢ

Where sᵢ is the current recommendation state, aᵢ is the executed recommendation result, and rᵢ is a feedback result of the recommendation result obtained from the user.

The recommendation result discriminative model may calculate a similarity of the current recommendation state and of the recommendation result, with the data records in the historical behavior data of the user, thereby obtaining the feedback result. For example, the feedback result of the data record with the highest similarity may be used as the feedback of the currently inputted recommendation result.

(B) Calculation Based on Correlation Degree with Browsed Product

The recommendation result discriminative model may also calculate a feedback result based on a correlation degree between the current recommendation result and the products that have been recently browsed by the user. For example, the higher the correlation degree is, the better the feedback result is.

Taking the model structure shown in FIG. 4 as an example, the training process of the above model is as follows.

(1) randomly initialize g_{φ}(sₜ), P_{ϕ}(sₜ, aₜ) and f_{θ}(x);

(2) train parameters g_{φ}(sₜ), P_{ϕ}(sₜ, aₜ) and f_{θ}(x) using the historical behavior data of the user; and

(3) repeat the following steps 3a and 3b until a predetermined convergence condition is met.

(3a) the recommendation model generates the recommendation result based on the inputted historical behavior data of the user, and updates the model parameters of the recommendation model based on the evaluation feedback on the recommendation result obtained from the recommendation result discriminative model;

(3b) The recommendation result discriminative model uses the recommendation result of the recommendation model as a positive sample, randomly generates a negative sample, and uses the newly generated samples (including positive and negative samples) as a training set to update the model parameters of the recommendation result discriminative model.

The details of the training method of the recommendation model may refer to the implementation of the conventional technology, and detailed descriptions are omitted here. By the above offline training method according to the embodiment of the present disclosure, the offline trained recommendation model based on deep reinforcement learning can be obtained.

In step 205, one or more products are online-recommended using the offline-trained recommendation model.

In step 205, one or more products can be online-recommended using the trained recommendation model based on deep reinforcement learning. The recommendation model has been pre-trained based on the historical behavior data of the user in advance, thus a better recommendation result can be obtained even at an initial phase of implementing online, thereby improving user satisfaction with respect to the recommendation model.

Compared with the conventional technology, in the recommendation method based on deep reinforcement learning according to the embodiment of the present disclosure, the recommendation model is pre-trained offline using the product knowledge graph and the historical browsing behavior of the user, before implementing the recommendation model online. In this way, a better recommendation effect of the recommendation model can be achieved even at an initial phase of implementing online, thus the recommendation performance of the recommendation model can be improved and user satisfaction can be improved.

As another example of the embodiment of the present disclosure, in the above step 205, the model parameters of the recommendation model may also be updated online based on real-time feedback of the user on the recommendation result. In this way, the recommendation performance of the recommendation model can be further improved.

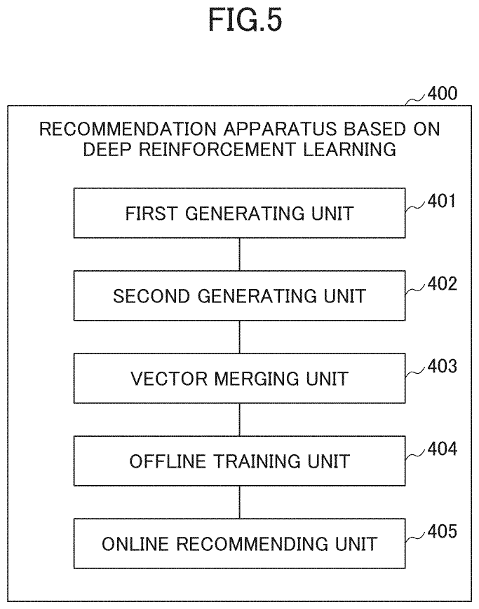

An embodiment of the present disclosure further provides a recommendation apparatus based on deep reinforcement learning. FIG. 5 is a block diagram illustrating the configuration of a recommendation apparatus based on deep reinforcement learning 400 according to an embodiment of the present disclosure. As shown in FIG. 5, the recommendation apparatus based on deep reinforcement learning 400 includes a first generating unit 401, a second generating unit 402, a vector merging unit 403, an offline training unit 404, and an online recommending unit 405.

The first generating unit 401 generates entity semantic information representation vectors of products based on a product knowledge graph.

The second generating unit 402 generates browsing context information representation vectors of the products based on historical browsing behavior of a user with respect to products.

The vector merging unit 403 merges the entity semantic information representation vectors and the browsing context information representation vectors of the respective products to obtain vectors of the products.

The offline training unit 404 constructs a recommendation model based on deep reinforcement learning. Then, the offline training unit 404 offline-trains the recommendation model based on the deep reinforcement learning using historical behavior data of the user, to obtain the offline-trained recommendation model. The products in the historical behavior data of the user are represented by the vectors of the products.

The online recommending unit 405 online-recommends one or more products using the offline-trained recommendation model.

In the recommendation apparatus based on deep reinforcement learning according to the embodiment of the present disclosure, the recommendation model is pre-trained offline using the product knowledge graph and the historical browsing behavior of the user, before implementing the recommendation model online. In this way, a better recommendation effect of the recommendation model can be achieved even at an initial phase of implementing online, thus the recommendation performance of the recommendation model can be improved and user satisfaction can be improved.

Preferably, the first generating unit 401 constructs a first function J_{TE} for calculating a sum of differences between respective values of a second function, based on first triplets and respective values of the second function based on second triplets based on entity topology-relation triplets. The first triplets are the entity topology-relation triplets that exist in the product knowledge graph, and the second triplets are the entity topology-relation triplets that do not exist in the product knowledge graph.

Then, the first generating unit 401 constructs a third function J_{AE} for calculating a sum of differences between respective values of the second function based on third triplets and respective values of the second function based on fourth triplets, based on entity attribute triplets. The third triplets are the entity attribute triplets that exist in the product knowledge graph, and the fourth triplets are the entity attribute triplets that do not exist in the product knowledge graph.

Then, the first generating unit 401 calculates a sum of a value of the first function and a value of the third function serving as a value of an objective function, and obtains vector representations of respective entities, relations and attributes in the product knowledge graph by optimizing the objective function, to obtain the entity semantic information representation vectors of the products.

Preferably, the second function is a function of a first vector and a second vector, and a value of the second function is positively or negatively related to a distance between the first vector and the second vector. The first vector is a sum of vector representations of the first two elements in the corresponding triplet. The second vector is a vector representation of the last element in the corresponding triplet.

Preferably, the last element in the entity attribute triplet is an attribute value. A vector of the attribute value is the last hidden state obtained by inputting the attribute value serving as a character sequence to a long short-term memory (LSTM) model.

Preferably, the second generating unit 402 inputs a product sequence composed of the products in the historical browsing behavior to a word-to-vector (Word2vec) model, to obtain the browsing context information representation vectors of the products.

Preferably, the vector merging unit 403 splices the entity semantic information representation vectors and the browsing context information representation vectors of the respective products to obtain the vectors of the products.

Preferably, the offline training unit 404 constructs and initializes the recommendation model based on the deep reinforcement learning and a recommendation result discriminative model. Then, the offline training unit 404 offline-trains the recommendation model and the recommendation result discriminative model using the historical behavior data of the user. The recommendation result discriminative model evaluates a recommendation result of the recommendation model, and feeds back an evaluation result to the recommendation model. The recommendation model updates one or more model parameters based on the evaluation result.

Preferably, the online recommending unit 405 updates the recommendation model based on feedback of the user on the recommendation result, after online-recommending the products using the offline-trained recommendation model.

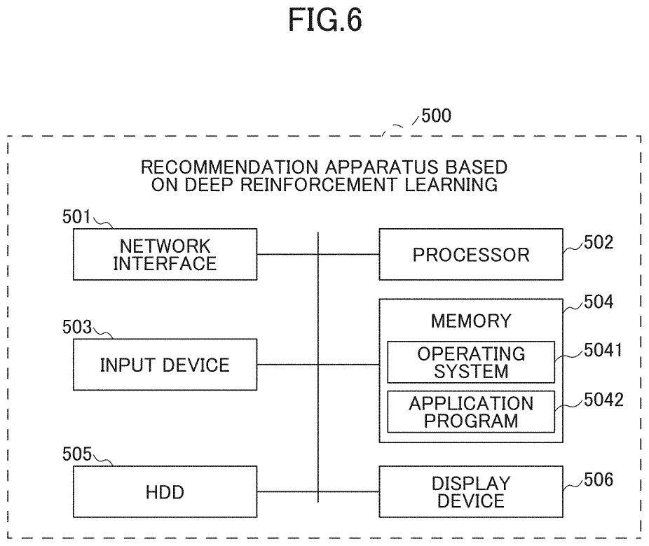

An embodiment of the present disclosure further provides a recommendation apparatus based on deep reinforcement learning. FIG. 6 is a block diagram illustrating the configuration of a recommendation apparatus based on deep reinforcement learning according to another embodiment of the present disclosure. As shown in FIG. 6, the recommendation apparatus based on deep reinforcement learning 500 includes a processor 502, and a memory 504 storing computer-executable instructions.

When the computer-executable instructions are executed by the processor 502, the processor 502 generates, based on a product knowledge graph, entity semantic information representation vectors of products; generates, based on historical browsing behavior of a user with respect to products, browsing context information representation vectors of the products; merges the entity semantic information representation vectors and the browsing context information representation vectors of the respective products to obtain vectors of the products; constructs a recommendation model based on deep reinforcement learning, and offline-trains, using historical behavior data of the user, the recommendation model based on the deep reinforcement learning, to obtain the offline-trained recommendation model, the products in the historical behavior data of the user being represented by the vectors of the products; and online-recommends one or more products using the offline-trained recommendation model.

Furthermore, as illustrated in FIG. 6, the recommendation apparatus based on deep reinforcement learning 500 further includes a network interface 501, an input device 503, a hard disk drive (HDD) 505, and a display device 506.

Each of the ports and each of the devices may be connected to each other via a bus architecture. The processor 502, such as one or more central processing units (CPUs), and the memory 504, such as one or more memory units, may be connected via various circuits. Other circuits such as an external device, a regulator, and a power management circuit may also be connected via the bus architecture. Note that these devices are communicably connected via the bus architecture. The bus architecture includes a power supply bus, a control bus and a status signal bus besides a data bus. The detailed description of the bus architecture is omitted here.

The network interface 501 may be connected to a network (such as the Internet, a LAN or the like), collect a corpus from the network, and store the collected corpus in the hard disk drive 505.

The input device 503 may receive various commands such as a predetermined threshold and its setting information input by a user, and transmit the commands to the processor 502 to be executed. The input device 503 may include a keyboard, a click apparatus (such as a mouse or a track ball), a touch board, a touch panel or the like.

The display device 506 may display a result obtained by executing the commands, for example, a recommendation result.

The memory 504 stores programs and data required for running an operating system, and data such as intermediate results in calculation processes of the processor 502, and the product knowledge graph, the historical behavior data of the user and the like.

Note that the memory 504 of the embodiments of the present disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which may be used as an external high-speed buffer. The memory 504 of the apparatus or the method is not limited to the described types of memory, and may include any other suitable memory.

In some embodiments, the memory 504 stores executable modules or a data structure, their subsets, or their superset, i.e., an operating system (OS) 5041 and an application program 5042.

The operating system 5041 includes various system programs for realizing various essential tasks and processing tasks based on hardware, such as a frame layer, a core library layer, a drive layer and the like. The application program 5042 includes various application programs for realizing various application tasks, such as a browser and the like. A program for realizing the method according to the embodiments of the present disclosure may be included in the application program 5042.

The method according to the above embodiments of the present disclosure may be applied to the processor 502 or may be realized by the processor 502. The processor 502 may be an integrated circuit chip capable of processing signals. Each step of the above method may be realized by instructions in a form of an integrated logic circuit of hardware in the processor 502 or a form of software. The processor 502 may be a general-purpose processor, a digital signal processor (DSP), an application specific integrated circuit (ASIC), field programmable gate array signals (FPGA) or other programmable logic device (PLD), a discrete gate or transistor logic, discrete hardware components capable of realizing or executing the methods, the steps and the logic blocks of the embodiments of the present disclosure. The general-purpose processor may be a micro-processor, or alternatively, the processor may be any common processor. The steps of the method according to the embodiments of the present disclosure may be realized by a hardware decoding processor, or combination of hardware modules and software modules in a decoding processor. The software modules may be located in a conventional storage medium such as a random access memory (RAM), a flash memory, a read-only memory (ROM), a erasable programmable read-only memory (EPROM), an electrically erasable programmable read-only memory (EEPROM), a register or the like. The storage medium is located in the memory 504, and the processor 502 reads information in the memory 504 and realizes the steps of the above methods in combination with hardware.

Note that the embodiments described herein may be realized by hardware, software, firmware, intermediate code, microcode or any combination thereof. For hardware implementation, the processor may be realized in one or more application specific integrated circuits (ASIC), digital signal processing devices (DSPD), programmable logic devices (PLD), field programmable gate array signals (FPGA), general-purpose processors, controllers, micro-controllers, micro-processors, or other electronic components or their combinations for realizing functions of the present disclosure.

For software implementation, the embodiments of the present disclosure may be realized by executing functional modules (such as processes, functions or the like). Software codes may be stored in a memory and executed by a processor. The memory may be implemented inside or outside the processor.

Preferably, when the computer-readable instructions are executed by the processor 502, the processor 502 may construct, based on entity topology-relation triplets, a first function J_{TE} for calculating a sum of differences between respective values of a second function based on first triplets and respective values of the second function based on second triplets, the first triplets being the entity topology-relation triplets that exist in the product knowledge graph, and the second triplets being the entity topology-relation triplets that do not exist in the product knowledge graph; construct, based on entity attribute triplets, a third function J_{AE} for calculating a sum of differences between respective values of the second function based on third triplets and respective values of the second function based on fourth triplets, the third triplets being the entity attribute triplets that exist in the product knowledge graph, and the fourth triplets being the entity attribute triplets that do not exist in the product knowledge graph; and calculate a sum of a value of the first function and a value of the third function serving as a value of an objective function, and obtain vector representations of respective entities, relations and attributes in the product knowledge graph by optimizing the objective function, to obtain the entity semantic information representation vectors of the products.

Preferably, the second function may be a function of a first vector and a second vector, and a value of the second function may be positively or negatively related to a distance between the first vector and the second vector. The first vector may be a sum of vector representations of the first two elements in the corresponding triplet. The second vector may be a vector representation of the last element in the corresponding triplet.

Preferably, the last element in the entity attribute triplet may be an attribute value. A vector of the attribute value may be the last hidden state obtained by inputting the attribute value serving as a character sequence to a long short-term memory (LSTM) model.

Preferably, when the computer-readable instructions are executed by the processor 502, the processor 502 may input a product sequence composed of the products in the historical browsing behavior to a word-to-vector (Word2vec) model, to obtain the browsing context information representation vectors of the products.

Preferably, when the computer-readable instructions are executed by the processor 502, the processor 502 may splice the entity semantic information representation vectors and the browsing context information representation vectors of the respective products to obtain the vectors of the products.

Preferably, when the computer-readable instructions are executed by the processor 502, the processor 502 may construct and initialize the recommendation model based on the deep reinforcement learning and a recommendation result discriminative model; and offline-train, using the historical behavior data of the user, the recommendation model and the recommendation result discriminative model. The recommendation result discriminative model may evaluate a recommendation result of the recommendation model, and may feed back an evaluation result to the recommendation model. The recommendation model may update one or more model parameters based on the evaluation result.

Preferably, when the computer-readable instructions are executed by the processor 502, the processor 502 may update, based on feedback of the user on the recommendation result, the recommendation model, after online-recommending the products using the offline-trained recommendation model.

An embodiment of the present disclosure further provides a non-transitory computer-readable recording medium having computer-executable instructions for execution by one or more processors. The execution of the computer-executable instructions cause the one or more processors to carry out a recommendation method based on deep reinforcement learning. The method includes generating, based on a product knowledge graph, entity semantic information representation vectors of products; generating, based on historical browsing behavior of a user with respect to products, browsing context information representation vectors of the products; merging the entity semantic information representation vectors and the browsing context information representation vectors of the respective products to obtain vectors of the products; constructing a recommendation model based on deep reinforcement learning, and offline-training, using historical behavior data of the user, the recommendation model based on the deep reinforcement learning, to obtain the offline-trained recommendation model, the products in the historical behavior data of the user being represented by the vectors of the products; and online-recommending one or more products using the offline-trained recommendation model.

As known by a person skilled in the art, the elements and algorithm steps of the embodiments disclosed herein may be implemented by electronic hardware or a combination of computer software and electronic hardware. Whether these functions are performed in hardware or software depends on the specific application and design constraints of the solution. A person skilled in the art may use different methods for implementing the described functions for each particular application, but such implementation should not be considered to be beyond the scope of the present disclosure.

As clearly understood by a person skilled in the art, for the convenience and brevity of the description, the specific working process of the system, the device and the unit described above may refer to the corresponding process in the above method embodiment, and detailed descriptions are omitted here.

In the embodiments of the present application, it should be understood that the disclosed apparatus and method may be implemented in other manners. For example, the device embodiments described above are merely illustrative. For example, the division of the unit is only a logical function division. In actual implementation, there may be another division manner, for example, units or components may be combined or be integrated into another system, or some features may be ignored or not executed. In addition, the coupling or direct coupling or communication connection described above may be an indirect coupling or communication connection through some interface, device or unit, and may be electrical, mechanical or the like.

The units described as separate components may be or may not be physically separated, and the components displayed as units may be or may not be physical units, that is to say, may be located in one place, or may be distributed to network units. Some or all of the units may be selected according to actual needs to achieve the objectives of the embodiments of the present disclosure.

In addition, each functional unit of the embodiments of the present disclosure may be integrated into one processing unit, or each unit may exist physically separately, or two or more units may be integrated into one unit.

The functions may be stored in a computer readable storage medium if the functions are implemented in the form of a software functional unit and sold or used as an independent product. Based on such understanding, the technical solution of the present disclosure, which is essential or contributes to the conventional technology, or a part of the technical solution, may be embodied in the form of a software product, which is stored in a storage medium, including instructions that are used to cause a computer device (which may be a personal computer, a server, or a network device, etc.) to perform all or a part of the steps of the methods described in the embodiments of the present disclosure. The above storage medium includes various media that can store program codes, such as a USB flash drive, a mobile hard disk, a ROM, a RAM, a magnetic disk, or an optical disk.

The present disclosure is not limited to the specifically described embodiments, and various modifications, combinations and replacements may be made without departing from the scope of the present disclosure.

What is claimed is:

1. A recommendation method based on deep reinforcement learning, the method comprising:
generating, based on a product knowledge graph, entity semantic information representation vectors of products;
generating, based on historical browsing behavior of a user with respect to products, browsing context information representation vectors of the products;
merging the entity semantic information representation vectors and the browsing context information representation vectors of the respective products to obtain vectors of the products;
constructing a recommendation model based on deep reinforcement learning, and offline-training, using historical behavior data of the user, the recommendation model based on the deep reinforcement learning, to obtain the offline-trained recommendation model, the products in the historical behavior data of the user being represented by the vectors of the products; and
online-recommending one or more products using the offline-trained recommendation model.

2. The recommendation method as claimed in claim 1,
wherein generating the entity semantic information representation vectors of the products based on the product knowledge graph includes
constructing, based on entity topology-relation triplets, a first function J_{TE} for calculating a sum of differences between respective values of a second function based on first triplets and respective values of the second function based on second triplets, the first triplets being the entity topology-relation triplets that exist in the product knowledge graph, and the second triplets being the entity topology-relation triplets that do not exist in the product knowledge graph;
constructing, based on entity attribute triplets, a third function J_{AE} for calculating a sum of differences between respective values of the second function based on third triplets and respective values of the second function based on fourth triplets, the third triplets being the entity attribute triplets that exist in the product knowledge graph, and the fourth triplets being the entity attribute triplets that do not exist in the product knowledge graph; and
calculating a sum of a value of the first function and a value of the third function serving as a value of an objective function, and obtaining vector representations of respective entities, relations and attributes in the product knowledge graph by optimizing the objective function, to obtain the entity semantic information representation vectors of the products.

3. The recommendation method as claimed in claim 2,
wherein the second function is a function of a first vector and a second vector, and a value of the second function is positively or negatively related to a distance between the first vector and the second vector,
wherein the first vector is a sum of vector representations of the first two elements in the corresponding triplet, and
wherein the second vector is a vector representation of the last element in the corresponding triplet.

4. The recommendation method as claimed in claim 3,
wherein the last element in the entity attribute triplet is an attribute value, and
wherein a vector of the attribute value is the last hidden state obtained by inputting the attribute value serving as a character sequence to a long short-term memory (LSTM) model.

5. The recommendation method as claimed in claim 4,
wherein generating the browsing context information representation vectors of the products based on the historical browsing behavior of the user with respect to the products includes
inputting a product sequence composed of the products in the historical browsing behavior to a word-to-vector (Word2vec) model, to obtain the browsing context information representation vectors of the products.

6. The recommendation method as claimed in claim 4,
wherein merging the entity semantic information representation vectors and the browsing context information representation vectors of the respective products includes
splicing the entity semantic information representation vectors and the browsing context information representation vectors of the respective products to obtain the vectors of the products.

7. The recommendation method as claimed in claim 1,
wherein constructing the recommendation model based on the deep reinforcement learning and offline-training the recommendation model based on the deep reinforcement learning using the historical behavior data of the user includes
constructing and initializing the recommendation model based on the deep reinforcement learning and a recommendation result discriminative model; and
offline-training, using the historical behavior data of the user, the recommendation model and the recommendation result discriminative model,
wherein the recommendation result discriminative model evaluates a recommendation result of the recommendation model, and feeds back an evaluation result to the recommendation model, and
the recommendation model updates one or more model parameters based on the evaluation result.

8. The recommendation method as claimed in claim 7, the method further comprising:
updating, based on feedback of the user on the recommendation result, the recommendation model, after online-recommending the products using the offline-trained recommendation model.

9. A recommendation apparatus based on deep reinforcement learning, the apparatus comprising:
a memory storing computer-executable instructions; and
one or more processors configured to execute the computer-executable instructions such that the one or more processors are configured to
generate, based on a product knowledge graph, entity semantic information representation vectors of products;
generate, based on historical browsing behavior of a user with respect to products, browsing context information representation vectors of the products;
merge the entity semantic information representation vectors and the browsing context information representation vectors of the respective products to obtain vectors of the products;
construct a recommendation model based on deep reinforcement learning, and offline-train, using historical behavior data of the user, the recommendation model based on the deep reinforcement learning, to obtain the offline-trained recommendation model, the products in the historical behavior data of the user being represented by the vectors of the products; and
online-recommend one or more products using the offline-trained recommendation model.

10. The recommendation apparatus as claimed in claim 9,
wherein the one or more processors are configured to
construct, based on entity topology-relation triplets, a first function J_{TE} for calculating a sum of differences between respective values of a second function based on first triplets and respective values of the second function based on second triplets, the first triplets being the entity topology-relation triplets that exist in the product knowledge graph, and the second triplets being the entity topology-relation triplets that do not exist in the product knowledge graph;
construct, based on entity attribute triplets, a third function J_{AE} for calculating a sum of differences between respective values of the second function based on third triplets and respective values of the second function based on fourth triplets, the third triplets being the entity attribute triplets that exist in the product knowledge graph, and the fourth triplets being the entity attribute triplets that do not exist in the product knowledge graph; and
calculate a sum of a value of the first function and a value of the third function serving as a value of an objective function, and obtain vector representations of respective entities, relations and attributes in the product knowledge graph by optimizing the objective function, to obtain the entity semantic information representation vectors of the products.

11. The recommendation apparatus as claimed in claim 10,
wherein the second function is a function of a first vector and a second vector, and a value of the second function is positively or negatively related to a distance between the first vector and the second vector,
wherein the first vector is a sum of vector representations of the first two elements in the corresponding triplet, and
wherein the second vector is a vector representation of the last element in the corresponding triplet.

12. The recommendation apparatus as claimed in claim 11,
wherein the last element in the entity attribute triplet is an attribute value, and
wherein a vector of the attribute value is the last hidden state obtained by inputting the attribute value serving as a character sequence to a long short-term memory (LSTM) model.

13. The recommendation apparatus as claimed in claim 12,
wherein the one or more processors are configured to
input a product sequence composed of the products in the historical browsing behavior to a word-to-vector (Word2vec) model, to obtain the browsing context information representation vectors of the products.

14. The recommendation apparatus as claimed in claim 12,
wherein the one or more processors are configured to
splice the entity semantic information representation vectors and the browsing context information representation vectors of the respective products to obtain the vectors of the products.

15. The recommendation apparatus as claimed in claim 9,
wherein the one or more processors are configured to
construct and initialize the recommendation model based on the deep reinforcement learning and a recommendation result discriminative model; and
offline-train, using the historical behavior data of the user, the recommendation model and the recommendation result discriminative model,
wherein the recommendation result discriminative model evaluates a recommendation result of the recommendation model, and feeds back an evaluation result to the recommendation model, and
the recommendation model updates one or more model parameters based on the evaluation result.

16. The recommendation apparatus as claimed in claim 15,
wherein the one or more processors are further configured to
update, based on feedback of the user on the recommendation result, the recommendation model, after online-recommending the products using the offline-trained recommendation model.

17. A non-transitory computer-readable recording medium having computer-executable instructions for execution by one or more processors, wherein, the computer-executable instructions, when executed, cause the one or more processors to carry out a recommendation method based on deep reinforcement learning, the method comprising:
generating, based on a product knowledge graph, entity semantic information representation vectors of products;
generating, based on historical browsing behavior of a user with respect to products, browsing context information representation vectors of the products;
merging the entity semantic information representation vectors and the browsing context information representation vectors of the respective products to obtain vectors of the products;
constructing a recommendation model based on deep reinforcement learning, and offline-training, using historical behavior data of the user, the recommendation model based on the deep reinforcement learning, to obtain the offline-trained recommendation model, the products in the historical behavior data of the user being represented by the vectors of the products; and
online-recommending one or more products using the offline-trained recommendation model.
